(19) United States
(12) Patent Application Publication
(10) Pub. No.: US 2024/0152466 A1
(43) Pub. Date: May 9, 2024

(54) SYSTEMS AND METHODS FOR COMPUTATIONAL ACCELERATION

(71) Applicant: Samsung Electronics Co., Ltd., Suwon-si (KR)

(72) Inventors: Marie Mai NGUYEN, Pittsburgh, PA (US); Rekha PITCHUMANI, Oak Hill, VA (US); Zongwang LI, Dublin, CA (US); Yang Seok KI, Palo Alto, CA (US)

(21) Appl. No.: 18/092,925

(22) Filed: Jan. 3, 2023

Related U.S. Application Data
(60) Provisional application No. 63/422,915, filed on Nov. 4, 2022.

(51) Int. Cl. G06F 12/109

(52) U.S. Cl. CPC G06F 12/109; G06F 2212/1041

(57) ABSTRACT

A system is described. The system may include a host processor, a host memory connected to the host processor, and a storage device connected to the host processor. An accelerator may communicate with the host processor. The accelerator may produce an output. The accelerator may also include a local memory, which may include a first region and a second region. The first region of the local memory of the accelerator may support a first mode, and the second region of the local memory of the accelerator may support a second mode. The accelerator may store the output of the accelerator in a destination, which may include the host memory, the storage device, the first region of the local memory of the accelerator, or the second region of the local memory of the accelerator.

### RELATED APPLICATION DATA

This application claims the benefit of U.S. Provisional Patent Application Ser. No. 63/422,915, filed Nov. 4, 2022, which is incorporated by reference herein for all purposes.

### FIELD

The disclosure relates generally to accelerators, and more particularly to managing access to accelerator output.

### BACKGROUND

Data centers may generate large amount of data during processing. To use this data, the data may be moved to a host memory, where it may be accessed by an application.

A need remains to improve access to output.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a system including an accelerator that may support improved access to accelerator output, according to embodiments of the disclosure.

FIG. 2 shows details of the machine of FIG. 1, according to embodiments of the disclosure.

FIG. 3A shows how a data mover may move the output of the accelerator of FIG. 1, according to embodiments of the disclosure.

FIG. 3B shows how the accelerator of FIG. 1 may store the output, according to embodiments of the disclosure.

FIG. 4 shows a flowchart of an example procedure for the system of FIG. 1, including the data mover of FIG. 3A, to move the output of the accelerator of FIG. 1, according to embodiments of the disclosure.

FIG. 5 shows a flowchart of an example procedure for the data mover of FIG. 3A to select a destination for the output of the accelerator of FIG. 1, according to embodiments of the disclosure.

FIG. 6 shows a flowchart of an example procedure for the accelerator of FIG. 1 to store the output, according to embodiments of the disclosure.

### SUMMARY

Embodiments of the disclosure include an accelerator. A destination for output of the accelerator may be selected. The accelerator may then store the output at the destination, or a data move may move the output of the accelerator to the destination.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

Accelerators provide for offloading of processing from the host processor. Depending on their location within the system, accelerators may also be able to access data directly from a storage device, which may provide for near-data processing. By accessing the data directly from the storage device, the time used to transfer data from the storage device to the host memory may be reduced or eliminated, resulting in faster processing.

Accelerators may store any output in a Device Local Memory (DLM). The host may then access the output from the DLM of the accelerator.

But before the host may use the output of the accelerator, the host may transfer the data from the DLM to the host memory. This additional data transfer operation may take additional time, which might offset the benefit of using the accelerator to perform the processing.

Embodiments of the disclosure address these issues by permitting the host to either access the data directly from the accelerator DLM or by managing the movement of the data, either to host memory or to persistent storage (i.e., non-volatile storage). The data management may be performed using a data mover (which may reside on the host) or by using Application Programming Interface (API) commands. The API commands may enable the accelerator to output the data directly to a target destination. Within the accelerator DLM, the output may be stored in either a host bias region or a device bias region. A data mover may orchestrate data movement automatically, and may be based on data hotness, memory speed, memory distance, data size, or persistency, among other criteria.

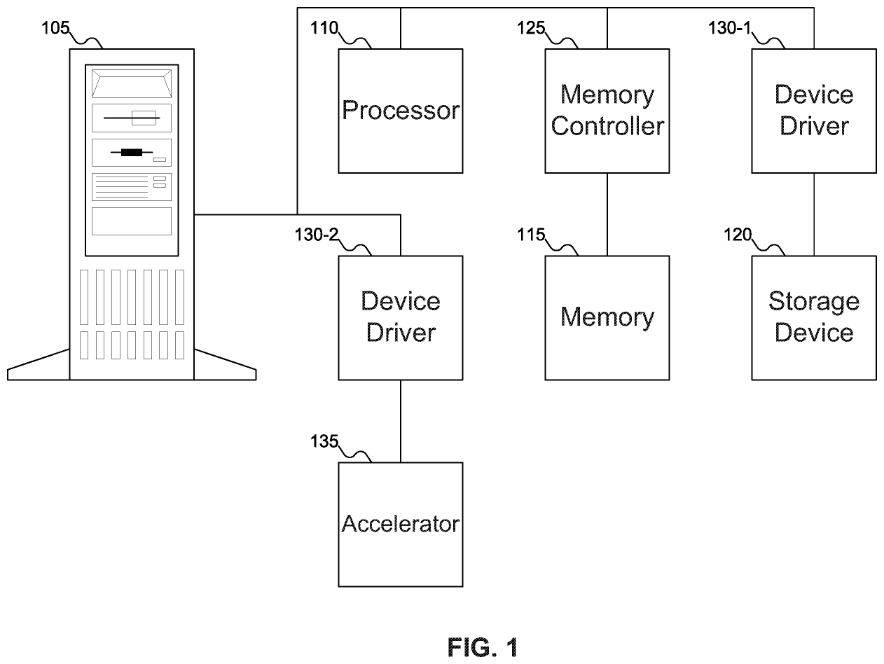

FIG. 1 shows a system including an accelerator that may support improved access to accelerator output, according to embodiments of the disclosure. In FIG. 1, machine 105, which may also be termed a host or a system, may include processor 110, memory 115, and storage device 120. Processor 110 may be any variety of processor. (Processor 110, along with the other components discussed below, are shown outside the machine for ease of illustration: embodiments of the disclosure may include these components within the machine.) While FIG. 1 shows a single processor 110, machine 105 may include any number of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115 (which may also be called a host memory or a system memory) may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may be a volatile or non-volatile memory, as desired. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115. When storage device 120 is used to support applications reading or writing data via some sort of file system, storage device 120 may be accessed using device driver 130-1. While FIG. 1 shows one storage device 120, there may be any number of storage devices in machine 105. Storage device 120 may support any desired protocol or protocols, including, for example, the Non-Volatile Memory Express (NVMe) protocol. Different storage devices 120 may support different protocols and/or interfaces. For example, storage device 120 might support a cache coherent interconnect protocol, which may support both block-level protocol (or any other higher level of granularity) access and byte-level protocol (or any other lower level of granularity) access to data on storage device 120. An example of such a cache coherent interconnect protocol is the Compute Express Link (CXL) protocol, which supports accessing data in blocks using the CXL.io protocol and accessing data in bytes using the CXL.mem protocol. In this manner, data on a CXL storage device may be accessed as either block-level data (like a Solid State Drive (SSD)) or byte-level data (such as a memory): the CXL storage device may be used to extend the system memory. In some embodiments of the disclosure, the CXL storage device may function solely to extend the system memory; in other embodiments of the disclosure, the CXL storage device may be used both to extend system memory and to function as a storage device (that is, to process file system requests to access data on the storage device). In some embodiments of the disclosure, storage device 120 may include both non-volatile storage (for example, flash memory) and volatile memory (for example, DRAM): the volatile memory may be used as a cache for data stored in the non-volatile storage.

While FIG. 1 uses the generic term “storage device”, embodiments of the disclosure may include any storage device formats that may benefit from the use of computational storage units, examples of which may include hard disk drives and SSDs. Any reference to “SSD” below should be understood to include such other embodiments of the disclosure. Further, different types of storage devices may be mixed. For example, one storage device 120 might be a hard disk drive, and another storage device 120 might be an SSD.

Machine 105 may be connected to a network (not shown in FIG. 1). The network may be any variety of network. The network may be a wired network or a wireless network. The network may be a Local Area Network (LAN), a Wide Area Network (WAN), a Metropolitan Area Network (MAN), or a world-wide network, such as the Internet, among other possibilities. The network may also include portions that may be different types of networks. For example, the network might include a wired portion and a wireless portion, or the network might include various LANs connected by the Internet.

To interface with the network, machine 105 may have a component (not shown in FIG. 1) to interface with the network. This component may be, for example, a network interface card.

Machine 105 may also include accelerator 135 (in some embodiments of the disclosure, accelerator 135 may also be called a computational storage unit or a computational storage device). Accelerator 135 may provide additional processing capability beyond that offered by processor 110. Accelerator 135 may offer any desired functionality. For example, in some embodiments of the disclosure, accelerator 135 may provide for offloading of processing from processor 110, which may free processor 110 to perform other tasks. In addition, in some embodiments of the disclosure, accelerator 135 may be used for near-data processing, accessing data from storage device 120 rather than having to load data from storage device 120 into memory 115 before processor 110 may process the data. In some embodiments of the disclosure, accelerator 135 may implement specific functions; in other embodiments of the disclosure, accelerator 135 may support downloading custom programs to be executed on data. In some embodiments of the disclosure, accelerator 135 may be separate from storage device 120 as shown; in other embodiments of the disclosure, accelerator 135 may be combined with storage device 120 into a single component. Accelerator 135 may be implemented in any desired manner, including, for example, a Field Programmable Gate Array (FPGA), an Application-Specific Integrated Circuit (ASIC), a Graphics Processing Unit (GPU), a General Purpose GPU (GPGPU), a Tensor Processing Unit (TPU), a Neural Processing Unit (NPU), or a Central Processing Unit (CPU) running appropriate software, among other possibilities.

In some embodiments of the disclosure, accelerator 135 may be accessed using device driver 130-2. (Device drivers 130-1 and 130-2 may be referred to collectively as device drivers 130 or drivers 130.) Device drivers 130 may provide a mechanism for the operating system of machine 105 to send requests to particular devices (such as storage device 120 and/or accelerator 135). In some embodiments of the disclosure, device drivers 130 may be implemented in a manner that enables a single device driver 130 to communicate with multiple components: in such embodiments of the disclosure, device drivers 130-1 and 130-2 may be the same device driver 130.

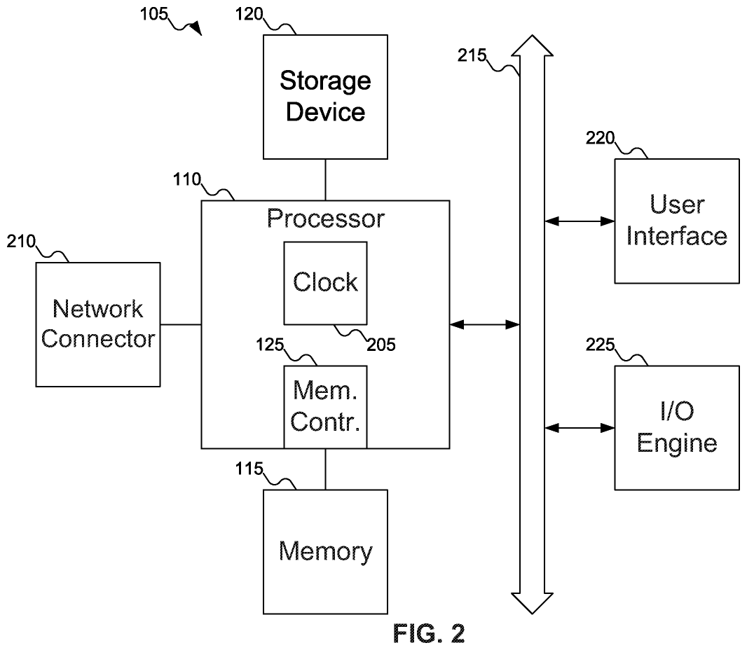

FIG. 2 shows details of machine 105 of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

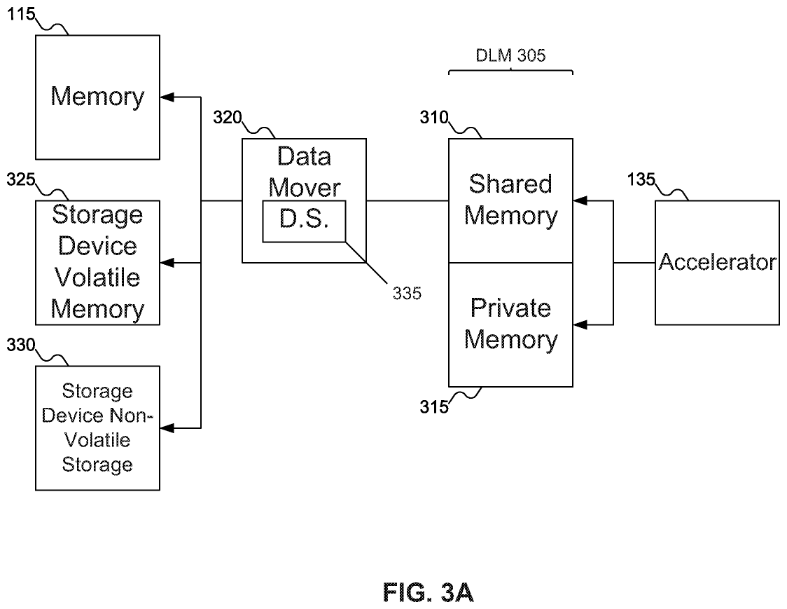

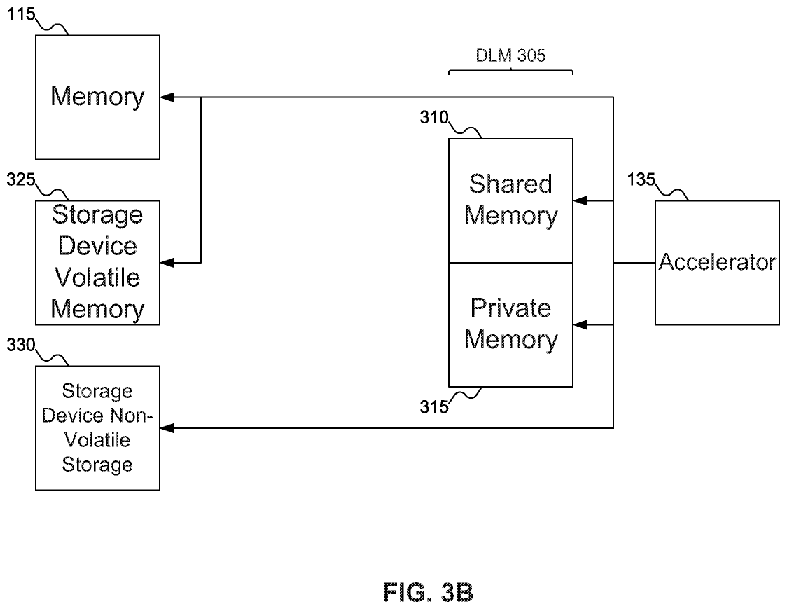

FIG. 3A shows how a data mover may move the output of the accelerator of FIG. 1, according to embodiments of the disclosure. In FIG. 3A, accelerator 135 may include memory 305, which may be called a device local memory or a local memory (to distinguish memory 305 from memory 115). Memory 305 may be local to accelerator 135. Memory 305 may be any desired variety of memory: for example, DRAM, SRAM, or High Bandwidth Memory (HBM).

Memory 305 may be divided into two regions: shared region 310 and private region 315. Shared region 310 may be thought of as a portion of memory 305 accessible to both accelerator 135 and processor 110 of FIG. 1, whereas private region 315 may be thought of as a portion of memory 305 accessible only to accelerator 135. The division between shared region 310 and private region 315 may be either physical or logical. That is, share region 310 and private region 315 may be physically different memories 305 within accelerator 135, or shared region 310 and private region 315 may share the same physical memory 305 but be logically separated.

Shared region 310 and private region 315 may each have a bias mode. Shared region 310 and private region 315 may have, for example, a host bias mode or a device bias mode. In host bias mode, a cache associated with processor 110 of FIG. 1 may be considered the definitive source for the data, and any component (such as accelerator 135 or processor 110 of FIG. 1) may check the cache to ensure they are accessing the most current data. In device bias mode, memory 305 of accelerator 135 may be considered the definitive source for the data, and any component (such as accelerator 135 or processor 110 of FIG. 1) may check memory 305 to ensure they are accessing the most current data. Put another way, if shared region 310 or private region 315 are in device bias mode, accelerator 135 may not need to check a cache of machine 105 of FIG. 1 to check for more current data; but if shared region 310 or private region 315 are in host bias mode, accelerator 135 may need to check a cache of machine 105 of FIG. 1 to check for more current data. (This check may matter more for input than for output, but the bias mode may also affect where data is stored. For example, if shared region 310 is in host bias mode, then accelerator 135 may need to ensure that if the memory address where the output is to be written is also stored in the cache of machine 105 of FIG. 1 that the output is also written to the cache of machine 105 of FIG. 1.)

Because private region 315 may be accessible only to accelerator 135, private region 315 may normally be in device bias mode. The bias mode for private region 315 may be changed, but there is no benefit to setting private region 315 to host bias mode if processor 110 of FIG. 1 does not access private region 315. On the other hand, shared region 310 may normally be in host bias mode. Shared region 310 may be changed to device bias mode if desired, but that change may have an impact on processor 110 of FIG. 1.

When accelerator 135 completes an operation, accelerator 135 may generate some output. This output may be a function of the operations performed by accelerator 135 and/or the data on which accelerator 135 is operating, among other possibilities. For example, if accelerator 135 is performing a data transformation, different input data may result in different output data. Similarly, performing different operations on the same input data may result in different output data. The manner in which the output is generated is not of particular interest, only that accelerator 135 generates the output.

Once the output has been generated, accelerator 135 may store the output somewhere in memory 305. Accelerator 135 may store the output in either shared region 310 or private region 315. The output might be accessible to processor 110 of FIG. 1 (or to data mover 320) only if stored in shared region 310 (and not if stored in private region 315).

The question might arise as to why accelerator output might be stored in private region 315, and therefore not be accessible to processor 110 of FIG. 1. The answer is that accelerator 135 might be performing multiple operations on the data. For example, if accelerator 135 implements two different mathematical functions, and processor 110 of FIG. 1 is interested in the result of applying both mathematical functions (in equation form, processor 110 of FIG. 1 is interested in f(g(x)), where f(x) and g(x) are different functions), then it may suffice for the output of the first operation to be stored in private region 315, and only store the output of the second operation in shared region 310.

If accelerator 135 uses a cache coherent interconnect protocol, accelerator 135 may use a cache command to store the output in either shared region 310 or private region 315. For example, if accelerator 135 uses the CXL protocol, accelerator 135 may use the CXL.cache command to store the output in either shared region 310 or private region 315.

Once the output has been stored in shared region 310, data mover 320 may be able to copy the output to another destination. Again, if accelerator 135 uses the CXL protocol, data mover 320 may access the output using either the CXL.mem or CXL.cache protocols to read the output from shared memory 310. Data mover 320 may then copy the output to any desired location, which may include, for example, memory 115, volatile memory 325 of storage device 120 of FIG. 1, or non-volatile storage 330 of storage device 120 of FIG. 1.

Note that if the output is to be left in shared region 310, the “copy” operation may be implicitly performed. That is, a copy of data from a location to itself is effectively a null operation. Thus, in some embodiments of the disclosure, data mover 320 might not visibly do anything if the output is to be left in shared region 310, but it may be understood that data mover 320 “copied” the output onto itself.

While the above description describes data mover 320 as “copying” the output of accelerator 135 to its eventual destination, a “move” operation may be understood as a combination of a “copy” operation and a “delete” operation. That is, to move the output from an address in shared region 310 to, say, an address in memory 115, the output may be copied from shared region 310 to memory 115, and then the output may be deleted from shared region 310. Thus, whether the data is ultimately “moved” or “copied”, both approaches may involve copying the output.

Data mover 320 may include destination selector 335 to select a destination for the output of accelerator 135. Destination selector 335 may use various criteria in determining where to move the output. These criteria may include, for example:
1) The hotness of the output of accelerator 135. For example, if the output is to be accessed relatively frequently, it may be useful to move the output to a location in memory 115 that might be more easily accessed than shared region 310. On the other hand, if the output is to be accessed relatively infrequently, it might be useful to move the output to a location in volatile memory 325 or non-volatile storage 330.
2) The speed of memory 115 as compared with the speed of memory 305. If memory 115 is faster to access than memory 305, it might be useful to move the output to a location that may be accessed more quickly than memory 305.
3) The distance to memory 115 as compared with the distance to memory 305. For example, if accelerator 135 is in another system remote from machine 105 of FIG. 1, it might be useful to copy the output to memory 115, which is closer to processor 110 of FIG. 1.
4) The size of the output. If the output is relatively large, leaving the output in memory 305 may limit the amount of memory 305 available to be used by accelerator 135. It might be useful to move the output out of memory 305 to increase the available memory 305 for use by accelerator 135.
5) The persistency of the output. If the output is to be kept available for a long time, it might be useful to move the output to non-volatile storage 330, so that any concern about the data being lost if power is interrupted may be minimized.

Data mover 320 may be implemented in any desired manner. Data mover 320 may be a process running on processor 110 of FIG. 1. Or, data mover 320 may be implemented as hardware using an FPGA, ASIC, GPU, GPGPU, TPU, NPU, CPU, or any other desired hardware. Data mover 320 may also be a separate hardware element from processor 110 of FIG. 1. Or, data mover 320 may be implemented as part of accelerator 135 (either as a process running on a processor of accelerator 135 or using an FPGA, ASIC, GPU, GPGPU, TPU, NPU, or CPU, among other possibilities).

While FIG. 3A shows data mover 320 as being responsible for selecting the destination for the output of accelerator 135, embodiments of the disclosure may have accelerator 135 include an Application Programming Interface (API) supporting commands that enable the user to move the output from shared region 310 to the desired destination. If the user moves the output manually, the user may select the destination based on the criteria above, or may select the destination using any other desired approach.

In FIG. 3A, the output of accelerator 135 may be moved by some element separate from accelerator 135 itself. (Even if data mover 320 is implemented within accelerator 135, data mover 320 may be distinct enough from accelerator 135 to be considered separate.) But in some embodiments of the disclosure, accelerator 135 might store the output directly in the desired destination. FIG. 3B illustrates such embodiments of the disclosure.

In FIG. 3B, accelerator 135 may store the output directly in any of shared region 310, private region 315, memory 115, volatile memory 325, or non-volatile storage 330. Accelerator 135 may select the appropriate destination based on criteria such as those discussed above, or processor 135 may use a command via an API of accelerator 135 to specify the desired destination.

While the above description suggests that in FIG. 3B system 105 of FIG. 1 may explicitly identify the destination where accelerator 135 should store the output of accelerator 135. But in some embodiments of the disclosure, the destination might not be specified. In such situations, accelerator 135 of FIG. 1 might include destination selector 335 of FIG. 3A to select the destination, or a destination, such as shared region 310 may be implicitly identified.

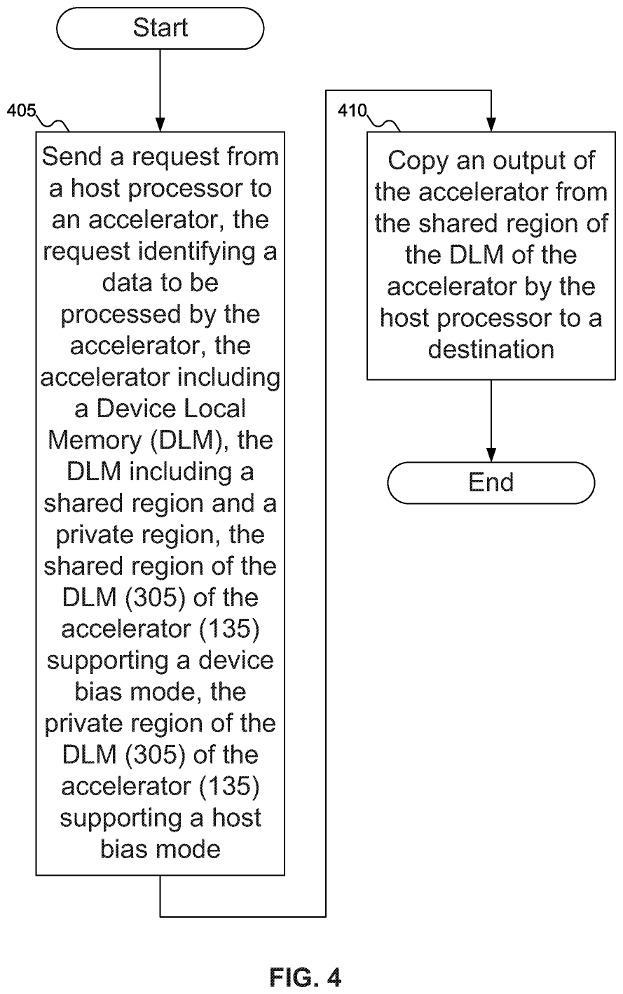

FIG. 4 shows a flowchart of an example procedure for system 105 of FIG. 1, including data mover 320 of FIG. 3A, to move the output of accelerator 135 of FIG. 1, according to embodiments of the disclosure. In FIG. 4, at block 405, processor 110 of FIG. 1 may send a request to accelerator 135 of FIG. 1. The request may identify a data to be processed by accelerator 135 of FIG. 1. At block 410, after accelerator 135 of FIG. 1 has processed the data and produced its output, processor 110 of FIG. 1 may copy the output from shared region 310 of FIGS. 3A-3B to the desired destination.

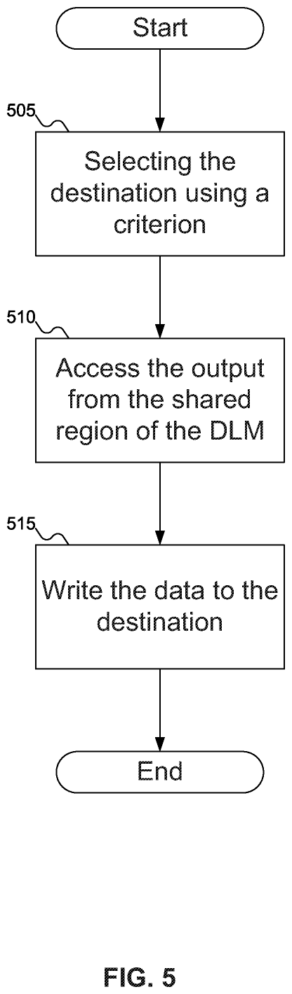

FIG. 5 shows a flowchart of an example procedure for data mover 320 of FIG. 3A to select a destination for the output of accelerator 135 of FIG. 1, according to embodiments of the disclosure. In FIG. 5, at block 505, destination selector 335 of FIG. 3A may select the destination to which data mover 320 of FIG. 3A may copy the output of accelerator 135 of FIG. 1. Destination selector 335 of FIG. 3A may use one or more criteria in selecting the destination for the output of accelerator 135 of FIG. 1. At block 510, data mover 320 of FIG. 3A may access the output of accelerator 135 of FIG. 1 from shared region 310 of FIGS. 3A-3B. At block 515, data mover 320 of FIG. 3A may write the output of accelerator 135 of FIG. 1 to the destination.

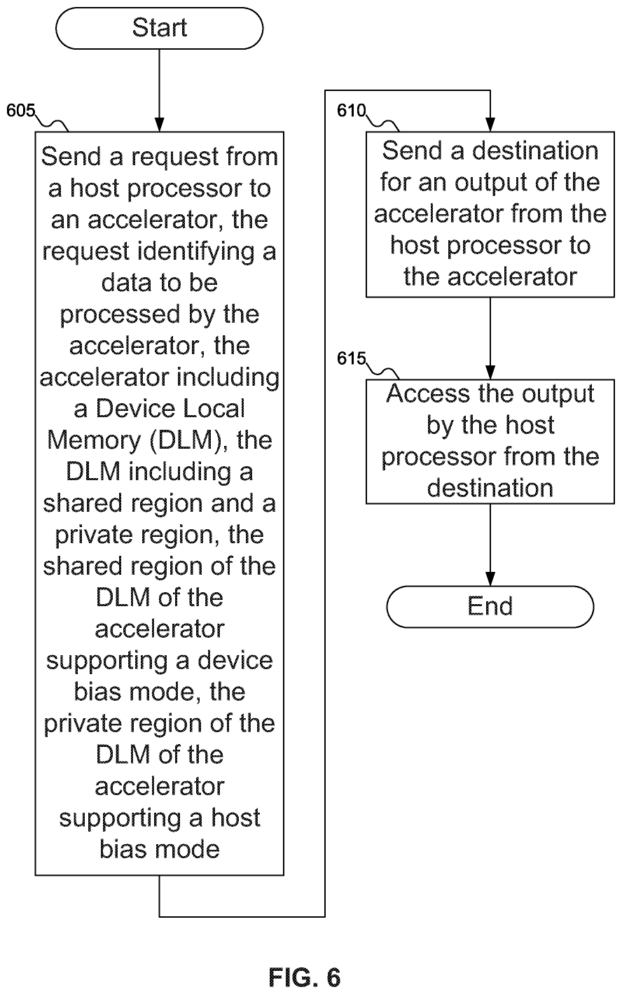

FIG. 6 shows a flowchart of an example procedure for accelerator 135 of FIG. 1 to store the output, according to embodiments of the disclosure. In FIG. 6, at block 605, processor 110 of FIG. 1 may send a request to accelerator 135 of FIG. 1. The request may identify a data to be processed by accelerator 135 of FIG. 1. The request may identify a data to be processed by accelerator 135 of FIG. 1. At block 610, processor 110 of FIG. 1 may send a destination to which accelerator 135 of FIG. 1 may store the output. This destination may be selected, for example, by destination selector 335 of FIG. 3A, using one or more criteria as described above. At block 615, host processor 110 of FIG. 1 may access the output of accelerator 135 of FIG. 1 from the destination.

In FIGS. 4-6, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may include an accelerator that may produce an output. The accelerator may store the output directly in a destination selected for the output, which may be in the host memory, the shared region of the device local memory, the private region of the device local memory, volatile memory of the storage device, or non-volatile storage of the storage device. Alternatively, the accelerator may store the output in the shared region of the device local memory, and a data mover (or the user, using Application Programming Interface (API) commands) may move the output from the shared region of the device local memory to the destination. By storing or moving the output to its destination in this manner, embodiments of the disclosure offer a technical advantage by potentially avoiding moving the data from the device local memory to the host memory before accessing and using the output of the accelerator.

When accelerators generate output data, for the operating system kernel to access the data, the host may copy the data from the memory of the accelerator to the memory of the host, after which the operating system kernel may access the data. This is inefficient, requiring multiple steps and transferring the data from the accelerator memory to the host memory.

Embodiments of the disclosure address these problems by having the accelerator write the data into the accelerator memory using CXL.cache protocol. In this manner, cache coherency of the data may be maintained, and the host may then access the data from the accelerator memory using the CXL.mem protocol.

The data may also be moved to other locations than in the accelerator memory. For example, the data may be placed in the host memory, or in persistent storage. Such placement may be based on, for example, the temperature of the data, the persistency of the data, or the size of the data.

Embodiments of the disclosure include methods for fast access to kernel output using CXL type-2 accelerators. A memory hierarchy with CXL type 2 accelerators may be used output staging. Output movement may be done by (1) the user using Application Programming Interfaces (APIs) or (2) the data mover automatically. APIs may also be used to change bias mode.

Embodiments of the disclosure include lower latency output transfer between host and accelerator kernels. There may be no output data copy overhead, and improved end-to-end application performance.

Data placement may use heuristics to decide where to place output data. Such heuristics may include, for example: data hotness/memory speed/distance: by default, use local DRAM, then accelerator DRAM, then CXL DRAM/SSD; data size: by default, use local DRAM, and if the data is too big, use CXL DRAM/SSD; persistency: if data needs persistency, use CXL SSD.

Embodiments of the disclosure may include user APIs. These APIs may include an API to allocate output data in a different memory: malloc(void*ptr, uint64_t data size, location_t memory_name), where ptr may be a data pointer, data size may be the size of the data in bytes, and memory_name may be the name of the memory device where data will be allocated: for example, local, accelerator, far.

Another API may be used to switch bias: switch bias (void*ptr, bias_t bias_mode), where ptr may be a data pointer and bias_mode may be a bias mode (for example, host or device bias)

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claims.

Embodiments of the disclosure may extend to the following statements, without limitation:

Statement 1. An embodiment of the disclosure includes a system, comprising:
a host processor;
a host memory connected to the host processor;
a storage device connected to the host processor; and
an accelerator communicating with the host processor, the accelerator configured to produce an output, the accelerator including a local memory, the local memory including a first region and a second region, the first region of the local memory of the accelerator supporting a first mode, the second region of the local memory of the accelerator supporting a second mode,
wherein the accelerator is configured to store the output of the accelerator in a destination, the destination including the host memory, the storage device, the first region of the local memory of the accelerator, or the second region of the local memory of the accelerator.

Statement 2. An embodiment of the disclosure includes the system according to statement 1, wherein:
the storage device includes a volatile memory and a non-volatile storage; and
the destination includes the host memory, the volatile memory of the storage device, the non-volatile storage of the storage device, the first region, or the second region.

Statement 3. An embodiment of the disclosure includes the system according to statement 1, wherein the local memory includes Dynamic Random Access Memory (DRAM), Static Random Access Memory (SRAM), or High Bandwidth Memory (HBM).

Statement 4. An embodiment of the disclosure includes the system according to statement 1, wherein:
the first mode includes a host bias mode; and
the second mode includes a device bias mode.

Statement 5. An embodiment of the disclosure includes the system according to statement 1, wherein the host processor and the accelerator communicate using a cache coherent interconnect protocol.

Statement 6. An embodiment of the disclosure includes the system according to statement 5, wherein the cache coherent interconnect protocol includes a Compute Express Link (CXL) protocol.

Statement 7. An embodiment of the disclosure includes the system according to statement 6, wherein the accelerator includes a CXL type 2 accelerator.

Statement 8. An embodiment of the disclosure includes the system according to statement 1, wherein the accelerator includes an interface command to identify the destination to the accelerator.

Statement 9. An embodiment of the disclosure includes the system according to statement 8, wherein the interface command includes an Application Programming Interface (API) command to identify the destination to the accelerator.

Statement 10. An embodiment of the disclosure includes the system according to statement 1, further comprising a data mover to copy the output of the accelerator from the first region to one of the host memory or the storage device.

Statement 11. An embodiment of the disclosure includes the system according to statement 10, wherein:
the storage device includes a volatile memory and a non-volatile storage; and
the data mover is configured to copy the output of the accelerator from the first region to one of the host memory, the volatile memory of the storage device, or the non-volatile storage of the storage device.

Statement 12. An embodiment of the disclosure includes the system according to statement 10, wherein the accelerator is configured to store the output of the accelerator in the first region.

Statement 13. An embodiment of the disclosure includes the system according to statement 10, wherein the data mover includes a destination selector to select the destination.

Statement 14. An embodiment of the disclosure includes the system according to statement 13, wherein the destination selector is configured to select the destination based at least in part on a hotness of the output of the accelerator, a first speed of the host memory, a second speed of the local memory of the accelerator, a first distance of the host memory, a second distance of the local memory of the accelerator, a size of the output of the accelerator, or a persistency of the output of the accelerator.

Statement 15. An embodiment of the disclosure includes the system according to statement 10, wherein the host processor includes the data mover.

Statement 16. An embodiment of the disclosure includes the system according to statement 10, wherein the accelerator includes the data mover.

Statement 17. An embodiment of the disclosure includes the system according to statement 10, wherein data mover is separate from the host processor and the accelerator.

Statement 18. An embodiment of the disclosure includes a method, comprising:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode; and
copying an output of the accelerator from the first region of the local memory of the accelerator by the host processor to a destination,
wherein the destination is one of a host memory or a storage device.

Statement 19. An embodiment of the disclosure includes the method according to statement 18, wherein the host processor is connected to the host memory and the storage device.

Statement 20. An embodiment of the disclosure includes the method according to statement 18, wherein:
the storage device includes a volatile memory and a non-volatile storage; and
the destination is one of the host memory, the volatile memory of the storage device, or the non-volatile storage of the storage device.

Statement 21. An embodiment of the disclosure includes the method according to statement 18, wherein the local memory includes Dynamic Random Access Memory (DRAM), Static Random Access Memory (SRAM), or High Bandwidth Memory (HBM).

Statement 22. An embodiment of the disclosure includes the method according to statement 18, wherein:
the first mode includes a host bias mode; and
the second mode includes a device bias mode.

Statement 23. An embodiment of the disclosure includes the method according to statement 18, wherein:
sending the request from the host processor to the accelerator includes sending the request from the host processor to the accelerator using a cache coherent interconnect protocol;
copying the output of the accelerator from the first region of the local memory of the accelerator by the host processor to the destination includes copying the output of the accelerator from the first region of the local memory of the accelerator by the host processor to the destination using the cache coherent interconnect protocol.

Statement 24. An embodiment of the disclosure includes the method according to statement 23, wherein:
sending the request from the host processor to the accelerator using a cache coherent interconnect protocol includes sending the request from the host processor to the accelerator using a Compute Express Link (CXL) protocol;
copying the output of the accelerator from the first region of the local memory of the accelerator by the host processor to the destination using the cache coherent interconnect protocol includes copying the output of the accelerator from the first region of the local memory of the accelerator by the host processor to the destination using the Compute Express Link (CXL) protocol.

Statement 25. An embodiment of the disclosure includes the method according to statement 24, wherein the accelerator includes a CXL type 2 accelerator.

Statement 26. An embodiment of the disclosure includes the method according to statement 18, wherein copying the output of the accelerator from the first region of the local memory of the accelerator by the host processor to the destination includes:
accessing the output of the accelerator from the first region of the local memory of the accelerator by the host processor; and
writing the output of the accelerator to the destination.

Statement 27. An embodiment of the disclosure includes the method according to statement 26, wherein copying the output of the accelerator from the first region of the local memory of the accelerator by the host processor to the destination further includes selecting the destination.

Statement 28. An embodiment of the disclosure includes the method according to statement 18, wherein copying the output of the accelerator from the first region of the local memory of the accelerator by the host processor to the destination includes copying the output of the accelerator from the first region of the local memory of the accelerator by the host processor to the destination using an interface command.

Statement 29. An embodiment of the disclosure includes the method according to statement 28, wherein the interface command includes an Application Programming Interface (API) command.

Statement 30. An embodiment of the disclosure includes the method according to statement 18, wherein copying the output of the accelerator from the first region of the local memory of the accelerator by the host processor to the destination includes copying the output of the accelerator from the first region of the local memory of the accelerator by a data mover to the destination.

Statement 31. An embodiment of the disclosure includes the method according to statement 30, wherein the data mover includes a process running on the host processor.

Statement 32. An embodiment of the disclosure includes the method according to statement 30, wherein the data mover includes a hardware element, the data mover different from the host processor.

Statement 33. An embodiment of the disclosure includes the method according to statement 30, wherein copying the output of the accelerator from the first region of the local memory of the accelerator by the data mover to the destination includes selecting the destination based at least in part on a criterion.

Statement 34. An embodiment of the disclosure includes the method according to statement 33, wherein the criterion includes a hotness of the output of the accelerator, a first speed of the host memory, a second speed of the local memory of the accelerator, a first distance of the host memory, a second distance of the local memory of the accelerator, a size of the output of the accelerator, or a persistency of the output of the accelerator.

Statement 35. An embodiment of the disclosure includes a method, comprising:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode;
sending a destination for an output of the accelerator from the host processor to the accelerator; and
accessing the output by the host processor from the destination,
wherein the destination is one of a host memory, a storage device, the first region of the local memory of the accelerator, or the second region of the local memory of the accelerator.

Statement 36. An embodiment of the disclosure includes the method according to statement 35, wherein the host processor is connected to the host memory and the storage device.

Statement 37. An embodiment of the disclosure includes the method according to statement 35, wherein:
the storage device includes a volatile memory and a non-volatile storage; and
the destination is one of the host memory, the volatile memory of the storage device, the non-volatile storage of the storage device, the first region of the local memory of the accelerator, or a second region of the local memory of the accelerator.

Statement 38. An embodiment of the disclosure includes the method according to statement 35, wherein the local memory includes Dynamic Random Access Memory (DRAM), Static Random Access Memory (SRAM), or High Bandwidth Memory (HBM).

Statement 39. An embodiment of the disclosure includes the method according to statement 35, wherein:
the first mode includes a host bias mode; and
the second mode includes a device bias mode.

Statement 40. An embodiment of the disclosure includes the method according to statement 35, wherein:
sending the request from the host processor to the accelerator includes sending the request from the host processor to the accelerator using a cache coherent interconnect protocol;
sending the destination for the output of the accelerator from the host processor to the accelerator includes sending the destination for the output of the accelerator from the host processor to the accelerator using the cache coherent interconnect protocol.

Statement 41. An embodiment of the disclosure includes the method according to statement 40, wherein:
the destination is the first region of the local memory of the accelerator; and
accessing the output by the host processor from the destination includes accessing the output by the host processor from the first region of the local memory of the accelerator using the cache coherent interconnect protocol.

Statement 42. An embodiment of the disclosure includes the method according to statement 40, wherein:
sending the request from the host processor to the accelerator using the cache coherent interconnect protocol includes sending the request from the host processor to the accelerator using a Compute Express Link (CXL) protocol;
sending the destination for the output of the accelerator from the host processor to the accelerator using the cache coherent interconnect protocol includes sending the destination for the output of the accelerator from the host processor to the accelerator using the Compute Express Link (CXL) protocol.

Statement 43. An embodiment of the disclosure includes the method according to statement 42, wherein:
the destination is the first region of the local memory of the accelerator; and
accessing the output by the host processor from the destination includes accessing the output by the host processor from the first region of the local memory of the accelerator using the CXL protocol.

Statement 44. An embodiment of the disclosure includes the method according to statement 42, wherein the accelerator includes a CXL type 2 accelerator.

Statement 45. An embodiment of the disclosure includes the method according to statement 35, wherein sending the destination for the output of the accelerator from the host processor to the accelerator includes sending the destination for the output of the accelerator from the host processor to the accelerator using an interface command.

Statement 46. An embodiment of the disclosure includes the method according to statement 45, wherein the interface command includes an Application Programming Interface (API) command.

Statement 47. An embodiment of the disclosure includes an article, the non-transitory storage medium having stored thereon instructions that, when executed by a machine, result in:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode; and
copying an output of the accelerator from the first region of the local memory of the accelerator by the host processor to a destination,
wherein the destination is one of a host memory or a storage device.

Statement 48. An embodiment of the disclosure includes the article according to statement 47, wherein the host processor is connected to the host memory and the storage device.

Statement 49. An embodiment of the disclosure includes the article according to statement 47, wherein:
the storage device includes a volatile memory and a non-volatile storage; and
the destination is one of the host memory, the volatile memory of the storage device, or the non-volatile storage of the storage device.

Statement 50. An embodiment of the disclosure includes the article according to statement 47, wherein the local memory includes Dynamic Random Access Memory (DRAM), Static Random Access Memory (SRAM), or High Bandwidth Memory (HBM).

Statement 51. An embodiment of the disclosure includes the article according to statement 47, wherein:
the first mode includes a host bias mode; and
the second mode includes a device bias mode.

Statement 52. An embodiment of the disclosure includes the article according to statement 47, wherein:
sending the request from the host processor to the accelerator includes sending the request from the host processor to the accelerator using a cache coherent interconnect protocol;
copying the output of the accelerator from the first region of the local memory of the accelerator by the host processor to the destination includes copying the output of the accelerator from the first region of the local memory of the accelerator by the host processor to the destination using the cache coherent interconnect protocol.

Statement 53. An embodiment of the disclosure includes the article according to statement 52, wherein:
sending the request from the host processor to the accelerator using a cache coherent interconnect protocol includes sending the request from the host processor to the accelerator using a Compute Express Link (CXL) protocol;
copying the output of the accelerator from the first region of the local memory of the accelerator by the host processor to the destination using the cache coherent interconnect protocol includes copying the output of the accelerator from the first region of the local memory of the accelerator by the host processor to the destination using the Compute Express Link (CXL) protocol.

Statement 54. An embodiment of the disclosure includes the article according to statement 53, wherein the accelerator includes a CXL type 2 accelerator.

Statement 55. An embodiment of the disclosure includes the article according to statement 47, wherein copying the output of the accelerator from the first region of the local memory of the accelerator by the host processor to the destination includes:
accessing the output of the accelerator from the first region of the local memory of the accelerator by the host processor; and
writing the output of the accelerator to the destination.

Statement 56. An embodiment of the disclosure includes the article according to statement 55, wherein copying the output of the accelerator from the first region of the local memory of the accelerator by the host processor to the destination further includes selecting the destination.

Statement 57. An embodiment of the disclosure includes the article according to statement 47, wherein copying the output of the accelerator from the first region of the local memory of the accelerator by the host processor to the destination includes copying the output of the accelerator from the first region of the local memory of the accelerator by the host processor to the destination using an interface command.

Statement 58. An embodiment of the disclosure includes the article according to statement 57, wherein the interface command includes an Application Programming Interface (API) command.

Statement 59. An embodiment of the disclosure includes the article according to statement 47, wherein copying the output of the accelerator from the first region of the local memory of the accelerator by the host processor to the destination includes copying the output of the accelerator from the first region of the local memory of the accelerator by a data mover to the destination.

Statement 60. An embodiment of the disclosure includes the article according to statement 59, wherein the data mover includes a process running on the host processor.

Statement 61. An embodiment of the disclosure includes the article according to statement 59, wherein the data mover includes a hardware element, the data mover different from the host processor.

Statement 62. An embodiment of the disclosure includes the article according to statement 59, wherein copying the output of the accelerator from the first region of the local memory of the accelerator by the data mover to the destination includes selecting the destination based at least in part on a criterion.

Statement 63. An embodiment of the disclosure includes the article according to statement 62, wherein the criterion includes a hotness of the output of the accelerator, a first speed of the host memory, a second speed of the local memory of the accelerator, a first distance of the host memory, a second distance of the local memory of the accelerator, a size of the output of the accelerator, or a persistency of the output of the accelerator.

Statement 64. An embodiment of the disclosure includes an article, the non-transitory storage medium having stored thereon instructions that, when executed by a machine, result in:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode;
sending a destination for an output of the accelerator from the host processor to the accelerator; and
accessing the output by the host processor from the destination,
wherein the destination is one of a host memory, a storage device, the first region of the local memory of the accelerator, or the second region of the local memory of the accelerator.

Statement 65. An embodiment of the disclosure includes the article according to statement 64, wherein the host processor is connected to the host memory and the storage device.

Statement 66. An embodiment of the disclosure includes the article according to statement 64, wherein:
the storage device includes a volatile memory and a non-volatile storage; and
the destination is one of the host memory, the volatile memory of the storage device, the non-volatile storage of the storage device, the first region of the local memory of the accelerator, or a second region of the local memory of the accelerator.

Statement 67. An embodiment of the disclosure includes the article according to statement 64, wherein the local memory includes Dynamic Random Access Memory (DRAM), Static Random Access Memory (SRAM), or High Bandwidth Memory (HBM).

Statement 68. An embodiment of the disclosure includes the article according to statement 64, wherein:
the first mode includes a host bias mode; and
the second mode includes a device bias mode.

Statement 69. An embodiment of the disclosure includes the article according to statement 64, wherein:
sending the request from the host processor to the accelerator includes sending the request from the host processor to the accelerator using a cache coherent interconnect protocol;
sending the destination for the output of the accelerator from the host processor to the accelerator includes sending the destination for the output of the accelerator from the host processor to the accelerator using the cache coherent interconnect protocol.

Statement 70. An embodiment of the disclosure includes the article according to statement 69, wherein:
the destination is the first region of the local memory of the accelerator; and
accessing the output by the host processor from the destination includes accessing the output by the host processor from the first region of the local memory of the accelerator using the cache coherent interconnect protocol.

Statement 71. An embodiment of the disclosure includes the article according to statement 69, wherein:
sending the request from the host processor to the accelerator using the cache coherent interconnect protocol includes sending the request from the host processor to the accelerator using a Compute Express Link (CXL) protocol;
sending the destination for the output of the accelerator from the host processor to the accelerator using the cache coherent interconnect protocol includes sending the destination for the output of the accelerator from the host processor to the accelerator using the Compute Express Link (CXL) protocol.

Statement 72. An embodiment of the disclosure includes the article according to statement 71, wherein:
the destination is the first region of the local memory of the accelerator; and
accessing the output by the host processor from the destination includes accessing the output by the host processor from the first region of the local memory of the accelerator using the CXL protocol.

Statement 73. An embodiment of the disclosure includes the article according to statement 71, wherein the accelerator includes a CXL type 2 accelerator.

Statement 74. An embodiment of the disclosure includes the article according to statement 64, wherein sending the destination for the output of the accelerator from the host processor to the accelerator includes sending the destination for the output of the accelerator from the host processor to the accelerator using an interface command.

Statement 75. An embodiment of the disclosure includes the article according to statement 74, wherein the interface command includes an Application Programming Interface (API) command.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A system, comprising:
a host processor;
a host memory connected to the host processor;
a storage device connected to the host processor; and
an accelerator communicating with the host processor, the accelerator configured to produce an output, the accelerator including a local memory, the local memory including a first region and a second region, the first region of the local memory of the accelerator supporting a first mode, the second region of the local memory of the accelerator supporting a second mode,
wherein the accelerator is configured to store the output of the accelerator in a destination, the destination including the host memory, the storage device, the first region of the local memory of the accelerator, or the second region of the local memory of the accelerator.

2. The system according to claim 1, wherein:
the storage device includes a volatile memory and a non-volatile storage; and
the destination includes the host memory, the volatile memory of the storage device, the non-volatile storage of the storage device, the first region, or the second region.

3. The system according to claim 1, wherein the local memory includes Dynamic Random Access Memory (DRAM), Static Random Access Memory (SRAM), or High Bandwidth Memory (HBM).

4. The system according to claim 1, wherein the accelerator includes an interface command to identify the destination to the accelerator.

5. The system according to claim 1, further comprising a data mover to copy the output of the accelerator from the first region to one of the host memory or the storage device.

6. The system according to claim 5, wherein:
the storage device includes a volatile memory and a non-volatile storage; and
the data mover is configured to copy the output of the accelerator from the first region to one of the host memory, the volatile memory of the storage device, or the non-volatile storage of the storage device.

7. The system according to claim 5, wherein the data mover includes a destination selector to select the destination.

8. The system according to claim 7, wherein the destination selector is configured to select the destination based at least in part on a hotness of the output of the accelerator, a first speed of the host memory, a second speed of the local memory of the accelerator, a first distance of the host memory, a second distance of the local memory of the accelerator, a size of the output of the accelerator, or a persistency of the output of the accelerator.

9. A method, comprising:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode; and
copying an output of the accelerator from the first region of the local memory of the accelerator by the host processor to a destination,
wherein the destination is one of a host memory or a storage device.

10. The method according to claim 9, wherein:
the storage device includes a volatile memory and a non-volatile storage; and
the destination is one of the host memory, the volatile memory of the storage device, or the non-volatile storage of the storage device.

11. The method according to claim 9, wherein:
sending the request from the host processor to the accelerator includes sending the request from the host processor to the accelerator using a cache coherent interconnect protocol;
copying the output of the accelerator from the first region of the local memory of the accelerator by the host processor to the destination includes copying the output of the accelerator from the first region of the local memory of the accelerator by the host processor to the destination using the cache coherent interconnect protocol.

12. The method according to claim 9, wherein copying the output of the accelerator from the first region of the local memory of the accelerator by the host processor to the destination includes:
accessing the output of the accelerator from the first region of the local memory of the accelerator by the host processor; and
writing the output of the accelerator to the destination.

13. The method according to claim 12, wherein copying the output of the accelerator from the first region of the local memory of the accelerator by the host processor to the destination further includes selecting the destination.

14. The method according to claim 9, wherein copying the output of the accelerator from the first region of the local memory of the accelerator by the host processor to the destination includes copying the output of the accelerator from the first region of the local memory of the accelerator by the host processor to the destination using an interface command.

15. The method according to claim 9, wherein copying the output of the accelerator from the first region of the local memory of the accelerator by the host processor to the destination includes copying the output of the accelerator from the first region of the local memory of the accelerator by a data mover to the destination.

16. The method according to claim 15, wherein copying the output of the accelerator from the first region of the local memory of the accelerator by the data mover to the destination includes selecting the destination based at least in part on a criterion.

17. The method according to claim 16, wherein the criterion includes a hotness of the output of the accelerator, a first speed of the host memory, a second speed of the local memory of the accelerator, a first distance of the host memory, a second distance of the local memory of the accelerator, a size of the output of the accelerator, or a persistency of the output of the accelerator.

18. A method, comprising:
sending a request from a host processor to an accelerator, the request identifying a data to be processed by the accelerator, the accelerator including a local memory, the local memory including a first region and a second region, the first region of the local memory of the accelerator supporting a first mode, the second region of the local memory of the accelerator supporting a second mode;
sending a destination for an output of the accelerator from the host processor to the accelerator; and
accessing the output by the host processor from the destination,
wherein the destination is one of a host memory, a storage device, the first region of the local memory of the accelerator, or the second region of the local memory of the accelerator.

19. The method according to claim 18, wherein:
the storage device includes a volatile memory and a non-volatile storage; and
the destination is one of the host memory, the volatile memory of the storage device, the non-volatile storage of the storage device, the first region of the local memory of the accelerator, or a second region of the local memory of the accelerator.

20. The method according to claim 18, wherein sending the destination for the output of the accelerator from the host processor to the accelerator includes sending the destination for the output of the accelerator from the host processor to the accelerator using an interface command.
